(19) United States
(12) Patent Application Publication
(10) Pub. No.: US 2003/0190121 A1
(43) Pub. Date: Oct. 9, 2003

(54) Athermal tunable filter with wavelength and intensity responses based on volume phase hologram

(76) Inventors: Fang Luo, State College, PA (US); Shizhuo Yin, State College, PA (US); Yunlong Sheng, Ste-Foy (CA)

Correspondence Address: OGILVY RENAULT, 1981 MCGILL COLLEGE AVENUE, SUITE 1600, MONTREAL, QC, H3A2Y3, CA

(21) Appl. No.: 10/409,052

(22) Filed: Apr. 9, 2003

Related U.S. Application Data
(60) Provisional application No. 60/371,174, filed on Apr. 9, 2002.

(51) Int. Cl. G02B 6/34; G02B 6/28

(52) U.S. Cl. 385/37; 385/24

(57) ABSTRACT

The present invention relates to an athermal tunable filter in which the wavelength and intensity responses of the filter can be independently tuned by moving the location of the filter. The filter is fabricated by recording multiple volume phase holographic gratings in highly stable photosensitive glasses (e.g. Ge-doped fused silica optic fiber preforms). The athermal operation is realized by an innovative design, in which the shift of the effective grating period induced by the thermal-optic effect is automatically compensated by the shift of incident and output beam angles. In addition, by recording the gratings in selected areas, the intensity response of the filter can also be independently tuned. This innovative tunable filter has many applications including, compact reconfigurable optical add/drop multiplexers (ROADM), dynamic gain equalizers, optical performance monitor (OPM), tunable chromatic dispersion compensation module, WDM combiner, tunable wavelength stabilizer, tunable lasers, and compact spectroscopy.

### CROSS-REFERENCE TO RELATED APPLICATIONS

This application claims priority on U.S. provisional patent application serial No. 60/371,174 filed on Apr. 9, 2002.

### FIELD OF THE INVENTION

The invention relates to athermal tunable filters. More specifically, it relates to athermal tunable filters with wavelength and power responses based on volume phase hologram.

### BACKGROUND OF THE INVENTION

The wide acceptance of the Internet is creating a fast growth in communication bandwidth demand, and many carriers are turning to wavelength division multiplexing (WDM) to achieve the necessary increase in the capacity of their existing fiber networks. The next generation of the dense WDM (DWDM) components will be tunable devices. Low cost, compact reconfigurable optical add/drop multiplexers (ROADM), Dynamic Gain Equalizers (DGE), Variable Optical Attenuators (VOA), tunable lockers and tunable lasers will be required for the next generation WDM systems, especially in the access and metro networks, to increase network usage efficiency and reduce the operation cost by eliminating the cost of service personnel traveling to manually reconfigure the network. In addition, firmware can be updated or replaced remotely without service interruption.

Volume Phase Hologram-based Filters (VPHF) recently emerged as an enabling technology for the next generation tunable devices in DWDM network and bio-photonics applications.

The major advantages of VPHF are as follows: It is a component of solid state, compact size and low cost. It has high diffraction efficiency, high wavelength selectivity and high resolution with very narrow wavelength bandwidth response up to 12.5 GHz. Unlike the Fiber Bragg Gratings (FBG) filter, no circulator is required when using the VPHF filter. Unlike conventional FBG's and Thin Film Filters (TFF's), the VPHF has both good angular and wavelength selectivity. The angular selectivity adds another tuning dimension for the filter. Unlike FBG's and TFF's, multiple WDM filters with different wavelength responses can be written in the same substrate simultaneously. This increases the tuning functionality of the devices and further reduces the footprint and cost of individual channels. Since multiple WDM filters are written in the same piece of material, it is convenient to achieve hitless operation during the filter tuning process. The filter wavelength response characteristics (such as bandwidth, profile, numerical aperture) can be flexibly controlled by tuning the grating refractive index modulation, grating period, grating curvature and shape.

Most current VPHF vendors use the VPHF written on dichromatic gelatin films (DCG) and photorefractive crystals, such as doped LiNbO₃ crystals, photosensitive polymers and photorefractive glasses. For example, ONDAX Inc. recently developed DWDM products using a set of volume Bragg gratings written in photorefractive crystals. However, the DCG, fixed LiNbO₃ crystals and photosensitive polymers materials still suffer from the long term reliability problems related to the material stability. The photorefractive glass, proposed by PD-LD Inc. in a white paper entitled “Volume Bragg gratings: A new platform technology for WDM applications” published in 2003 and authored by Volodin et al., is also a relatively new material but requires a complicated processing procedure.

Besides the long term stability issue, another major limitation comes from the thermal drift. The wavelength response of the filters shifts when the ambient temperature changes. For example, the ONDAX system has a temperature dependent wavelength response. In DWDM applications, a thermal related wavelength shift smaller than 1 pm/° C. is needed. Unfortunately, conventional photosensitive materials, e.g. doped LiNbO₃ materials or even the photosensitive glasses, have a much larger thermal shift. For example, the thermal-optic constant for fused silica is about 10⁻⁵/° C., which corresponds to a thermal related wavelength shift as large as 10 pm/° C. Obviously, this wavelength shift is too large for DWDM applications. Thus, to deploy a VPHF in a DWDM system, a temperature controller is needed, resulting in bulky size, high power consumption and high cost.

Note that, in telecom systems, temperature control should be avoided as much as possible due to the following reasons: it increases system power consumption, increases the footprint, and makes it difficult to achieve latching operation.

In the FBG, temperature compensation is realized by adding a negative thermal expansion jacket layer (e.g. using a negative thermal expansion ceramic) outside the FBG. However, one cannot simply copy the same approach in VPHF. Due to the use of much larger cross-sections (e.g. greater than 1 mm×1 mm) of volume phase hologram, external negative thermal expansion jacket layer is no longer very effective for temperature compensation.

Thus, there is a need in the art for achieving athermal VPHF and apply it to DWDM optical communication systems.

### SUMMARY OF THE INVENTION

Accordingly, an object of the present invention is to provide an athermal volume phase hologram filter (VPHF).

Another object of the present invention is to tune the power response of the VPHF.

Still another object of the present invention is to provide a tunable device of low cost, reliable, small footprint and capable of hitless tuning operation.

This device can be directly applicable in the Dense Wavelength Division Multiplexing (DWDM) network to tunable filters, Reconfigurable Optical Add/Drop Multiplexers (ROADM), Dynamic Gain Equalizer (DGE), Optical Performance Monitor (OPM), Variable Optical Attenuator (VOA) and to compact Raman spectroscopy and fluorescent detection-based DNA sequencing for biochemical and biomedical applications. Potential applications of this tunable filter include tunable chromatic dispersion compensation module (DCM), pump combiner, WDM combiner, tunable wavelength stabilizer (tunable locker) and tunable lasers.

According to a first broad aspect of the present invention, there is provided a method for filtering an input optical signal, comprising: providing a volume phase hologram; directing the input signal on the volume phase hologram at an input angle, the input angle being modified as a function of temperature whereby to compensate for an effect of temperature on the volume phase hologram; collecting light from the volume phase hologram.

According to a second broad aspect of the present invention, there is provided an athermal filter comprising: a volume phase hologram; an input optical device for directing the input signal on the volume phase hologram at an input angle; an angle controller for modifying the input angle as a function of temperature whereby to compensate for an effect of temperature on the volume phase hologram; a collecting device for collecting light from the volume phase hologram.

### BRIEF DESCRIPTION OF THE DRAWINGS

These and other features, aspects and advantages of the present invention will become better understood with regard to the following description and accompanying drawings wherein:

FIG. 1 is an athermal VPHF based reconfigurable OADM;

FIG. 2 is a plot of the Bragg resonant wavelength as a function of the ambient temperature, the solid line being without using a temperature compensation technique and the dashed line being with the temperature compensation technique of the present invention;

FIG. 3 is an athermal VPHF based reconfigurable OADM with hitless tuning capability;

FIG. 4 is an athermal VPHF based reconfigurable OADM with tuning of the intensity response;

FIG. 5 is an integrated VOA in the add/drop channel;

FIG. 6 shows the first scheme of a VPHF based DGE;

FIG. 7 shows the second scheme of a VPHF based DGE; and

FIG. 8 shows the third scheme of a VPHF based DGE.

### DETAILED DESCRIPTION OF THE PREFERRED EMBODIMENT

The present invention proposes an innovative use of the photosensitive glass that is the Ge-doped fused silica optic fiber preform and is currently widely used for optic fibers and fiber Bragg gratings (FBGs) as the material for the VPHF. This material has proven long term stability and reliability for both the material properties and the UV photosensitive index modulation.

The present invention also uses an innovative self-compensation optical architecture. The thermal drift of the optical grating period (i.e. nΛ) is automatically compensated by the thermal drift of the incident light beam angle. Thus, a total athermal operation is achieved.

The OADM is useful in the WDM network to add or drop specific predetermined wavelengths into and from the through traffic fiber. The next generation of OADM must be reconfigurable and highly integrated, and should dynamically select which wavelengths are added or dropped.

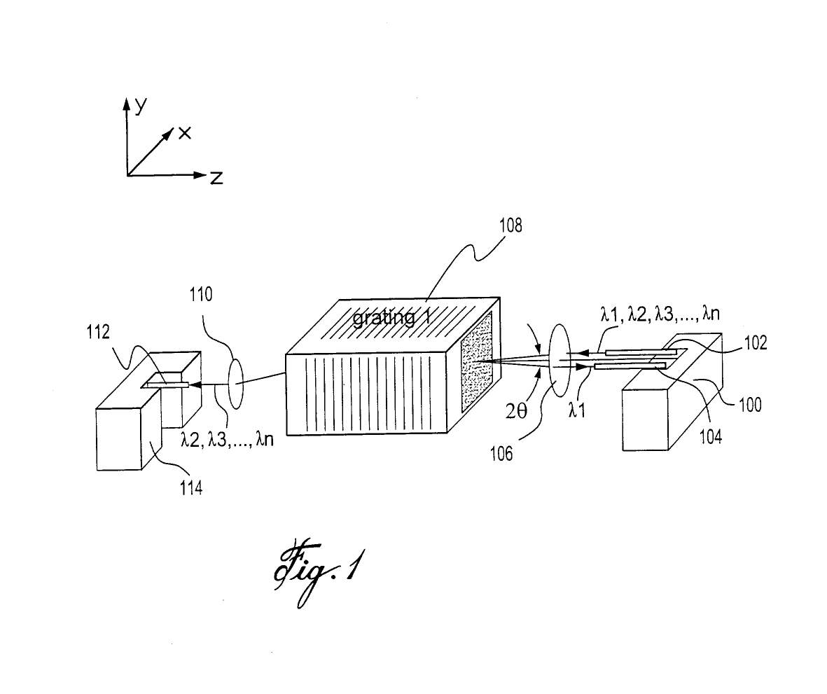

FIG. 1 depicts an athermal VPHF based ROADM, according to one embodiment of the present invention. The VPHF based ROADM includes an input fiber holder 100, input fiber 102, add/drop fiber 104, input end collimator lens 106, a set of volume phase holograms written in the same piece of photosensitive recording media 108 (only one hologram is shown in FIG. 1), output end collimator lens 110, through traffic fiber 112, through traffic fiber holder 114.

As seen in FIG. 1, input fiber 102 and add/drop fiber 104 are held by fiber holder 100. The two fibers are within the x-z plane. The end facet of fibers 102 and 104 are located in the front focal plane of input collimator lens 106. The input fiber 102 contains a set of wavelength channels (λ₁, λ₂, . . . , λₙ). After passing through the collimator lens 106, input light becomes a collimated plane wave, whose propagation direction has an angle θ with respect to the normal direction of the side surface of VPHF 108. Mathematically, angle θ is expressed as

$$θ = arctan ( \frac{{X}_{o}}{f} ) , \qquad ( 1 )$$

where Xₒ and f are the half-distance between the two fibers 102 and 104 and focal length of the collimator lens 106, respectively.

This input plane wave continues to travel and reaches the VPHF 108. For example, assume that the input light hits the first volume Bragg grating that has a grating constant Λ₁ and an average refractive index n. In this case, the Bragg condition is given by

$$2 n {Λ}_{1} cos ( arcsin ( \frac{sin ( θ )}{n} ) ) = {λ}_{1} . \qquad ( 2 )$$

In Eq. (2), we also assume that grating 1 corresponds to the resonant wavelength λ₁. In this case, wavelength λ2 ₁ is reflected back and collected by the add/drop fiber 104 and all the other wavelengths (λ₂, λ₃, . . . , λₘ) uninterruptedly pass through the VPHF 108 and collimator lens 110. This beam is then collected by through traffic fiber 112. Therefore, the wavelength λ₁ is dropped from the traffic.

As aforementioned, in photosensitive media, both Λ₁ and n may change as a function of ambient temperature, which in turn results in a shift of resonant wavelength λ₁. To overcome this problem, in the present invention, the fiber holder materials 100 and 114 are properly selected, and have a proper thermal expansion coefficient. When there is an ambient temperature change, the angle θ is also changed due to the change of Xₒ induced by the thermal expansion of holder 100. Thus, by properly selecting the thermal expansion coefficient and the geometry of holders 100 and 114, the changes in the optical path nΛ₁ and in the incident angle θ can automatically cancel each other over a large temperature range. Therefore, athermal operation is achieved.

Let us consider a numerical example. Assume that doped fused silica is used as the photosensitive material. The volume phase hologram is written in the material by UV light illumination via direct interference or phase mask. The system has the following parameters: grating constant Λ₁=500 nm; average refractive index n=1.5; focal lengths of collimator lenses 106 and 110 are f=1920 μm; Xₒ=62.5 μm at temperature 0° C.; thermal expansion constant of fused silica is 0.51×10⁻⁶/° C.; thermal optical constant of fused silica is 10⁻⁵/° C.; and linear thermal expansion coefficient of the fiber holder β=0.49 μm/° C.

In this case, angle θ at temperature T (in centigrade) is expressed as

$$θ = arctan ( \frac{62.5 + β T}{1920} ) \qquad ( 3 )$$

Note that this β value can be conveniently achieved by properly selecting the holder material. For example, one can use a 20 mm long copper holder. Since the thermal expansion constant of copper is about 2.5×10⁻⁵/° C.,

β=20 mm×2×10⁻⁵/° C.≈0.5 μm/° C.

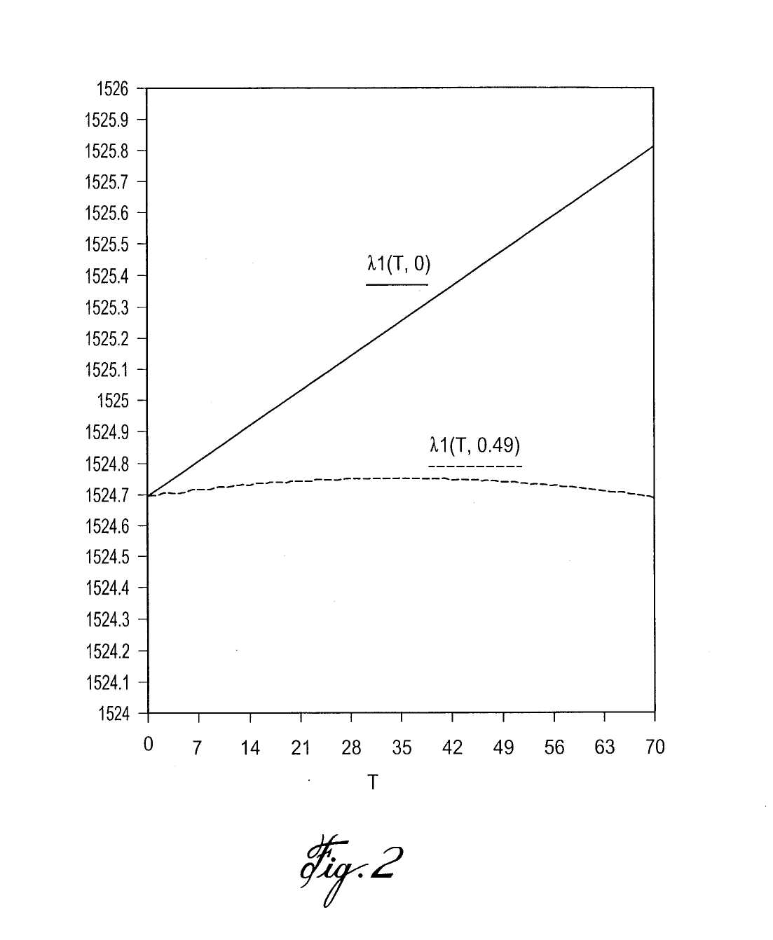

FIG. 2 depicts the resonant wavelength as a function of the ambient temperature T from 0° C. to 70° C. The solid line represents the case without temperature compensation (i.e. β=0). It can be seen that the wavelength shift is as long as 1 nm (˜14 pm/° C.). The dashed line represents the case with the temperature compensation technique of the present invention (i.e. β=0.49). In this case, the maximal wavelength shift is as small as 0.056 nm (˜0.8 pm/° C.), which is definitely within the acceptable range for telecommunication applications.

Note that the athermal packaging technique of the present invention can be applied to both VPHF in reflection and transmission, although the geometrical structures of the fiber holders 100 and 114 should be properly designed for the given ROADM architecture, the chosen photosensitive glass material and the fiber holder material properties.

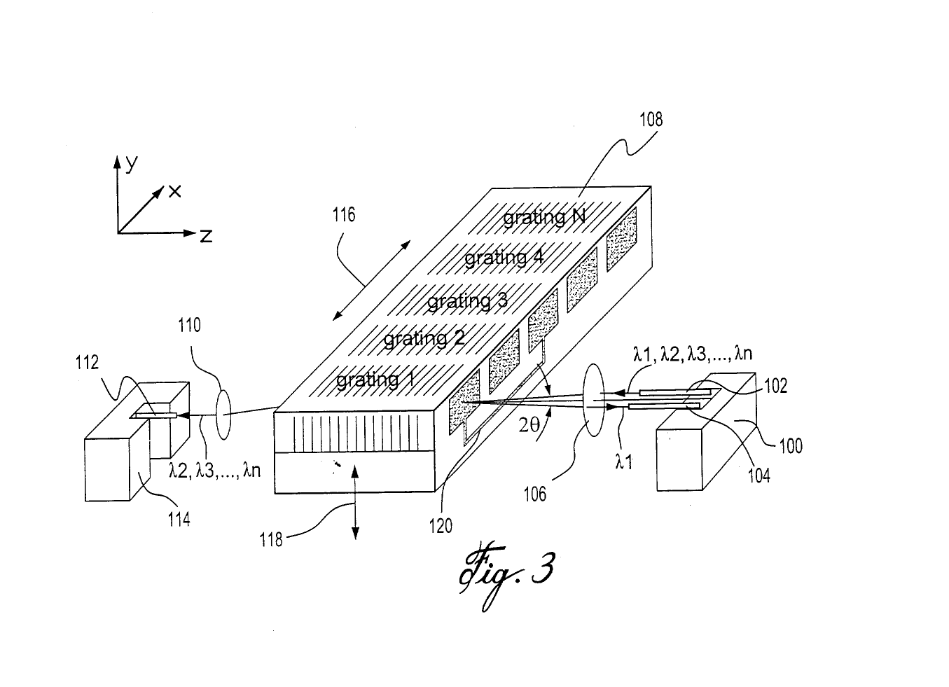

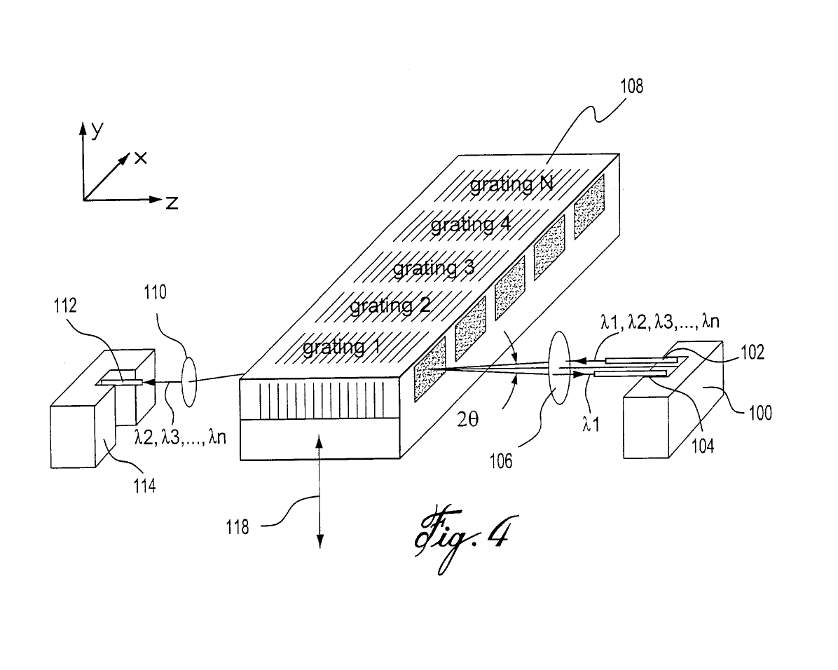

The present invention further uses an innovative architecture of the VPHF array as depicted in FIG. 3 to achieve hitless tuning capability for ROADM. An array of VPHFs is only written in certain parts of the media. For example, only the upper part of the media is written. This can be realized by only adding photosensitive dopant in the upper part of the fused silica preform in the fabrication process. In the present case, by moving the VPHF array using moving stages 116 and 118 along the track path 120, with respect to the ensemble of the fiber holders and collimating lenses, as depicted in FIG. 3, a hitless tuning can be realized. In other words, when tuning the filter from channel 1 (i.e. corresponding to grating 1) to channel 3 (i.e. corresponding to grating 3), the performance of all of the other channels (e.g. channel 2 corresponding to grating 2) will not be influenced. In FIGS. 3 and 4, linear moving stages 116 and 118 move in the x and y directions, respectively, and could be driven by a micro-motor, or a piezo-electric driver, or any other precise moving mechanisms such as magnetic field induced strain.

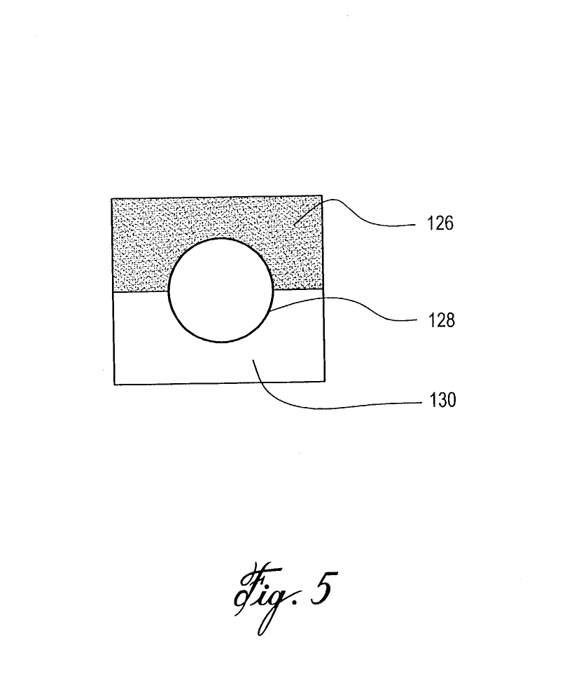

The present invention also includes an innovative approach for the implementation of tuning capacity of the power response of the VPHF. By simply moving the VPHF up and down with respect to the input plane wave beam using the moving stage 118 the beam power response of the VPHF for the reflected beam can be continuously tuned as shown in FIG. 4. Then tuning of the beam power by the VPHF is achieved, as depicted in FIG. 5. The variable optical attenuator (VOA) can be integrated in the add/drop channel of the system by simply moving the VPHF in a location, where only part of the volume phase hologram is illuminated. The light beam 128 then illuminates a portion of the grating area 126 and of an area without grating 130.

The present invention further includes an innovative design for a Dynamic Gain Equalizer (DGE) based on the VPHF. The Er-doped fiber amplifier (EDFA) used in the WDM network has a specific gain spectrum, which can vary from one EDFA to the other. The load and power losses in each channel of the WDM network can also vary in time. Thus, the DGE should equalize optical powers in WDM channels. The gain flattening can be continuous over the entire C- or L-band, or can be discrete, acting in each wavelength channel. The VPHF based DGE of the present invention is a discrete power equalizer. There are three schemes for the VPHF based DGE. In all of the three schemes, the set of VPHFs is in form of an one-dimensional array, and the VPHFs are written only in certain parts of the media, for example, only in the upper part of the media. This can be realized by only adding photosensitive dopant in the upper part of the fused silica fiber preform in the fabrication process.

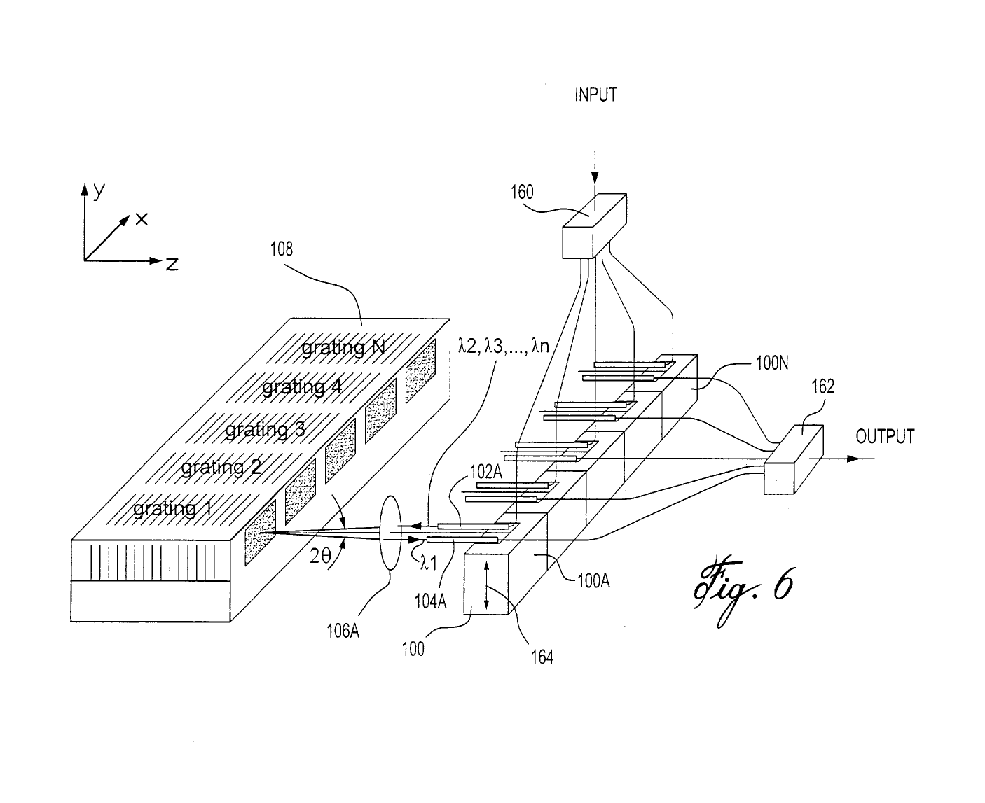

The first scheme uses a set of VPHFs plus a set of VOAs. The input signal is split equally into a number N of channels by a 1×N fiber splitter 160, where N is the number of channels whose powers are to be equalized. The split signal is then conducted by the fibers and distributed to the one dimensional array of N reflective VPHFs 108, as depicted in FIG. 6. In fact, there is a one-dimensional array of N input sets, which consists of a fiber holder 100, an input fiber 102, a collimator fiber 104 and a coupling lens 106. Each input set is mounted on a y-direction actuator 164. Each VPHF reflects a specific wavelength and is written only in the upper part of the substrate. Then, individually displacing up and down the input sets using the y-direction actuator 164 can tune the power of each the WDM channels individually to achieve dynamic gain equalization. The N reflected beams from the array of N VPHFs are collected by the collimator fiber 104 and are then combined by a N×1 fiber combiner 162 into the output of the DGE. Note that the input set is preferably packaged with the innovative self-compensation optical architecture described earlier.

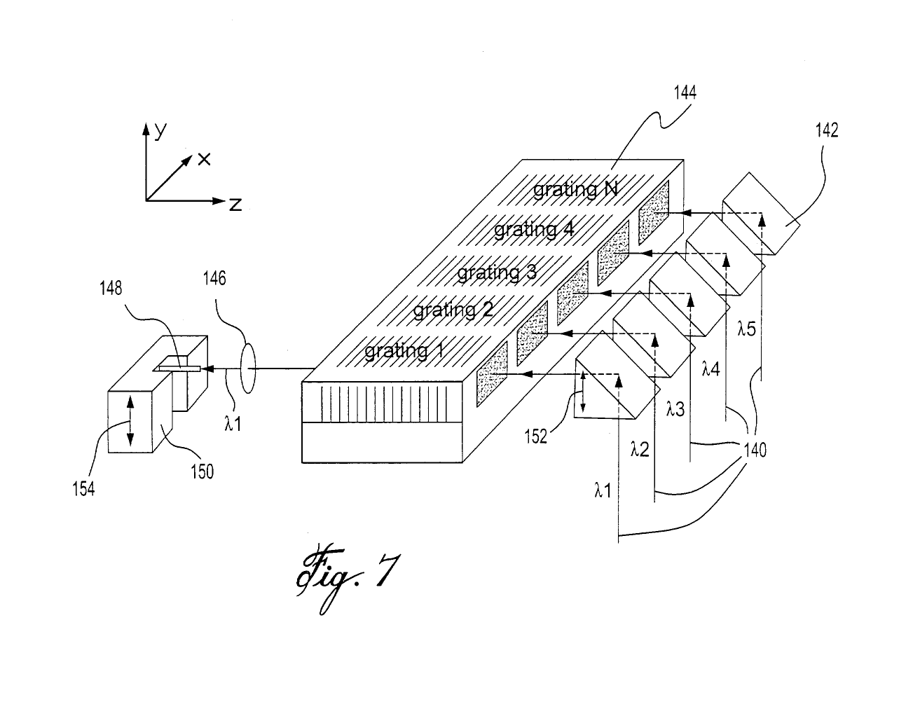

In the first scheme, the input signal is equally split into N channels, resulting in an inherent loss. In the second scheme, the input signal from the input fiber end passes through a collimator lens and becomes a collimated plane wave beam. The input signal containing a set of wavelength channels (λ₁, λ₂, . . . , λₙ) passes through the first transmission VPHF and is diffracted into a one dimensional array of spatially separated beams 140. This completes the demultiplexing operation. The input fiber, collimator lens and the transmission VPHF are not shown in FIG. 7. Each of the wavelength channel beams is then reflected by one of an array of prisms 142 towards an array of VPHFs 144. Each individual VPHF in the array 144 is designed and written for a specific wavelength corresponding to the input channel wavelength.

Each input wavelength channel beam is partially reflected back by the corresponding VPHF and loses a portion of the channel power. The remaining power in each wavelength channel is collected by a collimating lens 146 and coupled into the through traffic fiber 148. There is one set of collimating lens 146, traffic fiber 148 and fiber holder 150 for each channel. Only one of such a signal collecting set is depicted in FIG. 7. Each prism in the prism array 142 is mounted on a solid base and can be individually displaced up and down in the y-direction 152 along with the corresponding signal collecting set. The displacement is controlled by an array of y-direction stages 152 and 154, some of which are not shown in FIG. 7, in order to tune the power of each input wavelength channel and equalize the power in the channels.

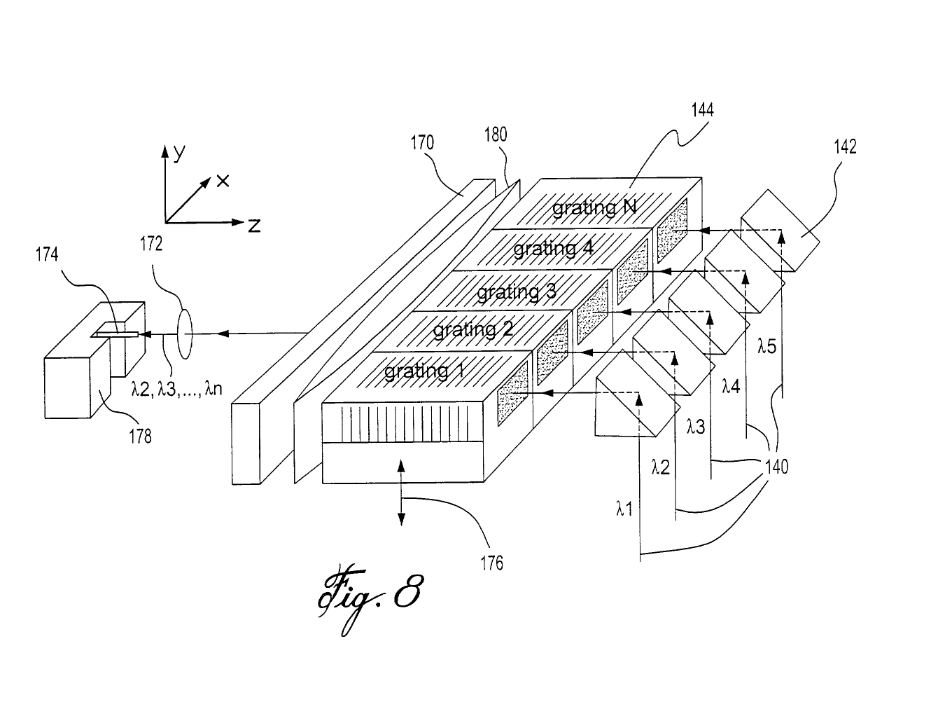

The third scheme is for the WDM system with the VPHF based DGE, which requires a combined output signal. A third VPHF is used to recombine the demultiplexed and power tuned signal beams, obtained in scheme 2 and depicted in FIG. 7, into a single output fiber. In this case, the input signal containing a set of wavelength channels (λ₁, λ₂, . . . , λₙ) passes through the first transmission VPHF and is diffracted into a one-dimensional array of spatially separated beams 140, which are directed to the array of VPHFs by an array of prisms 142, as shown in FIG. 8. Each VPHF reflects a part of the beam power of the corresponding wavelength. That creates power losses. Remaining channel beams are reoriented into appropriate angles by a collimating lens 180 and are then transmitted through the VPHFs, which combines the multiple wavelengths beams into a third VPH 170 into a single beam. The beam is then collected by a single collimator lens 172, through traffic fiber 174 and fiber holder 178. In this case, each individual VPHF in the VPHF array 144 can be displaced up and down by an individual y-direction stage 176, some of which are not shown in FIG. 8 in order to tune the portion of the beam power loss, which is reflected back by the VPHF.

Having described an athermal volume phase hologram based tunable, reconfiguration optical add/drop multiplexer, variable optical attenuator and dynamic gain equalizer in detail, those skilled in the art will appreciate that, given the present disclosure, modifications may be made to the invention without departing from the spirit of the inventive concept herein (e.g. larger number of input and output ports, reflection architectures, etc.). Therefore, it is not intended that the scope of the invention be limited to the specific and preferred embodiments illustrated and described.

What is claimed is:

1. A method of filtering an input optical signal, comprising:
providing a volume phase hologram;
directing said input signal on said volume phase hologram at an input angle, said input angle being modified as a function of temperature whereby to compensate for an effect of temperature on said volume phase hologram;
collecting light from said volume phase hologram.

2. A method as claimed in claim 1, wherein said volume phase hologram is fabricated from fused silica photosensitive glass.

3. A method as claimed in claim 1, wherein said providing comprises providing said volume phase hologram with a plurality of gratings.

4. A method as claimed in claim 3, further comprising displacing an entry point of said input signal on said volume phase hologram from one grating location of a first grating to another grating location of another grating without allowing said input signal to go through an intermediate grating, whereby to achieve hitless tuning.

5. A method as claimed in claim 1, wherein said providing comprises providing said volume phase hologram with a grating and wherein said directing comprises controlling said input signal to partially illuminate said grating, thereby tuning a power of said collected light.

6. A method as claimed in claim 5, further comprising displacing one of said volume phase hologram and said input optical device to control said illumination of said grating.

7. An athermal filter comprising:
a volume phase hologram;
an input optical device for directing said input signal on said volume phase hologram at an input angle;
an angle controller for modifying said input angle as a function of temperature whereby to compensate for an effect of temperature on said volume phase hologram;
a collecting device for collecting light from said volume phase hologram.

8. An athermal filter as claimed in claim 7, wherein said input optical device comprises an input fiber, an input fiber holder and an input optical lens and wherein said angle controller is said input fiber holder.

9. An athermal filter as claimed in claim 7, wherein said collecting device comprises a through-traffic fiber, a through traffic fiber holder and a through traffic optical lens.

10. An athermal filter as claimed in claim 8, wherein said collecting device comprises an add/drop fiber, an add/drop fiber holder and an add/drop optical lens and wherein said input fiber holder is said add/drop fiber holder and said input optical lens is said add/drop optical lens, and wherein said angle controller is said input fiber holder.

11. An athermal filter as claimed in claim 7, wherein said angle controller is an optical device holder having a thermal expansion compensating the thermal shift of a wavelength response of said volume phase hologram.

12. An athermal filter as claimed in claim 7, wherein said volume phase hologram is written in fused silica photosensitive glass.

13. An athermal filter as claimed in claim 7, wherein said volume phase hologram is written in photorefractive crystal.

14. An athermal filter as claimed in claim 7, wherein said volume phase hologram is written in polymer material.

15. An athermal filter as claimed in claim 7, wherein said volume phase hologram is written in one of liquid crystal and polymer dispersed liquid crystal.

16. An athermal filter as claimed in claim 7, wherein said volume phase hologram is tuned by one of an electric field, a magnetic field, thermal means and acoustic means.

17. An athermal filter as claimed in claim 8, wherein said optical lens is one of a grin lens and a cylindrical lens.

18. An athermal filter as claimed in claim 8, wherein said optical lens is one of a plane mirror and a curved mirror.

19. An athermal filter as claimed in claim 7 wherein said optical input device is displaced with respect to said volume phase hologram to tune the intensity of the light collected.

20. An athermal filter as claimed in claim 7, further comprising an actuator to displace said volume phase hologram.
